(19) United States
(12) Patent Application Publication
(10) Pub. No.: US 2024/0049055 A1
(43) Pub. Date: Feb. 8, 2024

(54) DISTRIBUTED ADAPTIVE RADIO CONFIGURATION

(71) Applicant: Aviat U.S., Inc., Austin, TX (US)

(72) Inventors: Ian McCallum, Innisfil (CA); Bradford Stimpson, Beeton (CA)

(21) Appl. No.: 18/365,597

(22) Filed: Aug. 4, 2023

Related U.S. Application Data
(60) Provisional application No. 63/370,502, filed on Aug. 5, 2022.

(51) Int. Cl. H04W 28/086; H04W 28/06

(52) U.S. Cl. CPC H04W 28/0861; H04W 28/06

(57) ABSTRACT

Disclosed are wireless communications systems including implementation of an adaptive distributed configuration of base stations. The base stations use an inter-base station protocol to exchange configuration data for use in configuring the base stations according to an identical solution independently determined by each of the base stations.

### FIELD OF THE INVENTION

The present disclosure relates to wireless communications systems, in particular, coordinated operation and configuration of base stations of a wireless communications system.

### BRIEF SUMMARY

According to a first aspect, there is provided a method for configuring a wireless network including a plurality of base stations and one or more data bases, the method including: exchanging data for base station configuration between the base stations and the one or more data bases; exchanging local base station configuration data between the base stations; and self-configuring each base station with use of a configuration processing provided at each of the base stations, based on the local base station configuration data exchanged between the base stations.

In some embodiments, exchanging data for base station configuration includes base stations sending local base station data to the one or more data bases.

In some embodiments, the local base station data includes GPS locations of the base stations.

In some embodiments, the local base station data includes data indicative of network conditions local to the base stations.

In some embodiments, exchanging data for base station configuration includes the one or more data bases generating local base station configuration data including alternative parameters or operating limitations based on the local base station data received by the one or more data bases.

In some embodiments, exchanging data for base station configuration includes the one or more data bases transmitting the local base station configuration data including alternative parameters or operating limitations to the base stations.

In some embodiments, the local base station configuration data includes a list of channels on which each base station may operate.

In some embodiments, exchanging local base station configuration data includes the base stations generating and exchanging packets according to an inter-base station protocol (IBSP).

In some embodiments, the packets generated according to the IBSP include a payload including the local base station configuration data and a hash of all payloads known to a base station.

In some embodiments, the IBSP packets are exchanged by base stations broadcasting IBSP packets to all other base stations in the wireless network system.

In some embodiments, exchanging local base station configuration data includes a base station determining that a hash function has not changed since a grace period has elapsed, and the base station subsequently commencing said self-configuring.

In some embodiments, the configuration processing provided at each of said base stations is the same and produces a same set of base station configurations including a configuration solution specific to the base station for self-configuring the base station.

In some embodiments, self-configuring is performed with use of the same configuration processing to coordinate operation of the base stations.

In some embodiments, self-configuration includes determining from said exchanged local base station configuration data a priority for each base station.

In some embodiments, self-configuration includes sorting said exchanged local base station configuration data based on a cardinality of alternative parameters in local base station configuration data and base station priority.

In some embodiments, cardinality of alternative parameters includes a number of channels on which the base station may operate on.

In some embodiments, self-configuration includes finding a configuration solution to mutually exclusive configurations using said sorting.

In some embodiments, self-configuration includes determining from said exchanged local base station configuration, data parameters to be synchronized with use of a performance metric.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates an example wireless network system implementing adaptive distributed configuration according to an embodiment.

FIG. 2 is a functional block diagram of adaptive distributed configuration according to an embodiment.

FIG. 3A illustrates exchanging data between the base stations and the one or more data bases for adaptive distributed configuration according to an embodiment.

FIG. 3B illustrates exchanging data using an inter-base station protocol between the base stations for adaptive distributed configuration according to an embodiment.

FIG. 3C illustrates self-configuration using the exchanged configuration data for adaptive distributed configuration according to an embodiment.

FIG. 4 illustrates an example of available bandwidth in accordance with regulatory requirements for a white space communications system located in proximity to TV broadcast stations.

FIG. 5 illustrates example messaging in the exchange of configuration data between a base station and a WSDB database (such as an FCC database) according to an embodiment.

FIG. 6 illustrates example messaging of a first base station shortly after powering up according to an embodiment.

FIG. 7 illustrates a first example messaging of a first base station and a second base station shortly after the second base station's powering up in the presence of the first base station according to an embodiment.

FIG. 8 illustrates a second example messaging of a first base station and a second base station shortly after the second base station's powering up in the presence of the first base station according to an embodiment.

FIG. 9 illustrates example messaging of a first base station, a second base station, and a third base station, shortly after the third base station's powering up in the presence of the first and second base stations according to an embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the scope of an invention as defined by the appended claims.

### DETAILED DESCRIPTION

A distributed set of base stations (BS) of a wireless communications network typically requires some configuration or management to ensure optimal and coordinated operation within the network. Typically, a distributed set of base stations can either each be manually configured, once in an initial configuration and then periodically as scheduled or as needed, or can be configured by communication and/or negotiation of each base station with a centralized element management system (EMS). In either case, the base station is essentially configured by external entities whether by an automated system or manually.

In some cases, when there are limited operational parameters or otherwise mutually exclusive resources which base stations may operate with and when individual base stations are to purposefully operate differently from one another, coordination is often preferred and sometimes necessary e.g. when base stations are to operate on different channels. In other cases, coordination is necessary or preferable to ensure similar functioning among the base stations, e.g. time synchronization of frame structures in some network systems. Coordination also may be preferable or necessary between base stations on either a local scale, in groups or in pairs, or on a global scale, involving all base stations of a wireless network.

Manual configuration can be time consuming, costly and/or inefficient, often involving a technician and can suffer from unnecessary down-time for a base station or a portion of the network, while automated configuration by a centralized EMS requires additional and costly network infrastructure and sophisticated hardware and/or software to communicate, negotiate with, and ultimately to configure the base stations.

To mitigate one or more of the problems associated with either manual or centralized configuration, distributed adaptive configuration of base stations in a communications network as described hereinbelow, may be employed.

In order to avoid the necessity of either manual or centralized configuration, the primary configuration operations are performed by the base stations themselves based on various exchanged configuration data. The configuration process is distributed in each of the base stations either in hardware, hardware configured by software executed therein, firmware, or equivalents thereof, and shall be referred to also as “configuration processing circuitry” or “configuration processing”.

The configuration of base stations within a network relies on base station specific information often depending upon information unique or local to the base station itself as well as operational parameters or limitations known to or determined by an entity external to the base stations. As was mentioned above, such operational parameters or limitations are preferred or necessary for coordination and operation of the base stations in the network, and can include requirements for base stations to work mutually exclusively of each other in some respects or to work in accord with one another in some respects.

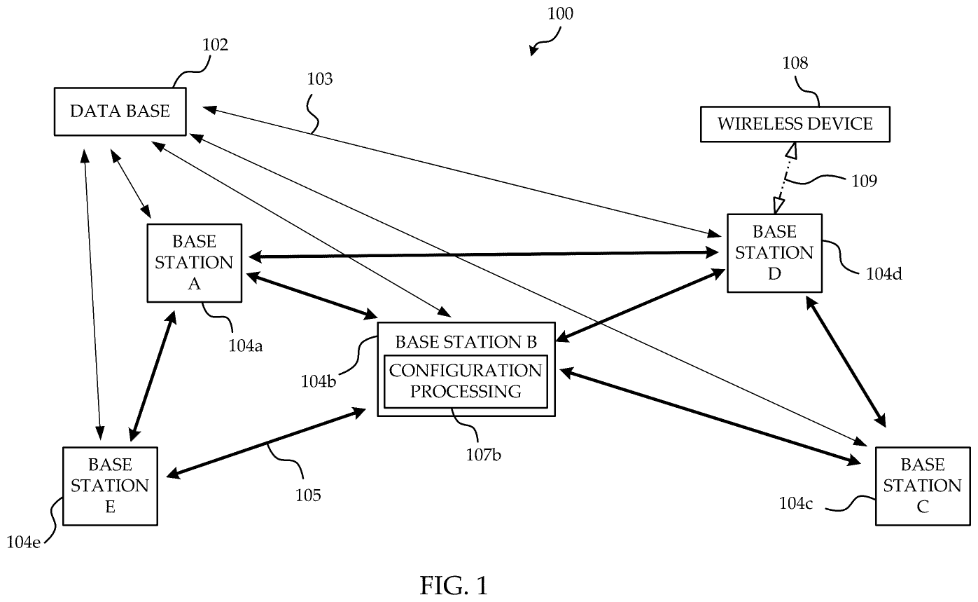

Referring now to FIG. 1, an example wireless network system 100 implementing adaptive distributed configuration according to an embodiment will now be discussed.

Generally, the network system 100 includes base stations 104, such as base stations A, B, C, D, and E 104a 104b 104c 104d 104e which are able to communicate to each other using an inter-base station protocol (IBSP) over links 105. One or more data bases DB 102 are present within the network for receiving base station specific information over links 103 from the base stations 104 and for providing to the base stations 104 base station specific configuration parameters over those links. Typically, the links 105 between base stations 104 for implementing the IBSP are not the same kind of wireless links 109 as those which the base stations 104 provide in the wireless network to the various mobile or client devices 108. The links 103 between the one or more data bases DB 102 and the base stations 104 also are typically not the same kind of links as those wireless links 109 which the base stations 104 form in the wireless network with the various devices 108, and moreover, the links between the one or more data bases 102 and the base stations 104 may not be the same kind of links as those between the base stations 104 themselves.

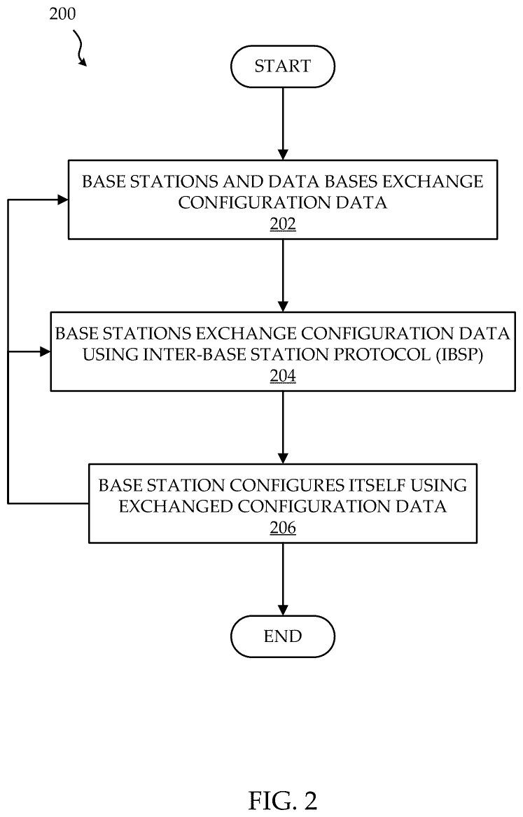

Each base station 104 in the network system 100 implements the same configuration processing to ensure the configurations arrived at in each of the base stations 104 are appropriately coordinated. Part of ensuring that the configuration processing of each base station 104 arrives at a coordinated configuration for the network, involves ensuring that each base station 104 has the same configuration processing using the same information. Referring also to FIG. 2, in some embodiments, the base stations 104 communicate 204 with each other via the IBSP over links 105 configuration data each has received from the one or more data bases 102. In some embodiments some of the unique or local base station data is also communicated over links 105. In some embodiments, once all of the base stations 104 possess the same base station data and configuration data, each base station 104 implements its configuration processing to determine the set of configuration parameters for the base stations 104 which manifests the coordinated functioning.

A method 200 of adaptive distributed configuration illustrated in FIG. 2, will now be discussed.

Each base station 104 communicates over links 103 to exchange data 202 with the one or more data bases 102. Generally, the one or more data bases 102 are provided with local base station data and the base stations 104 are then provided with the requisite base station configuration data, in the form of ground truth or selectable parameters and operating limitations and the like. Once the base stations 104 have the configuration data they communicate with one another over links 105 to exchange 204 the configuration data using the inter-base station protocol. Once the configuration data has propagated throughout the base stations 104 of the wireless network system 100, each base station configures itself 206 according to that exchanged configuration data with use of the configuration processing 107. In some embodiments, base station configuration 206 occurs simultaneously with the propagation and exchange of configuration data 204. As can be appreciated, as the wireless network system 100 changes, base stations are added or removed, the system 100 adapts using the various steps of the method 200 as required.

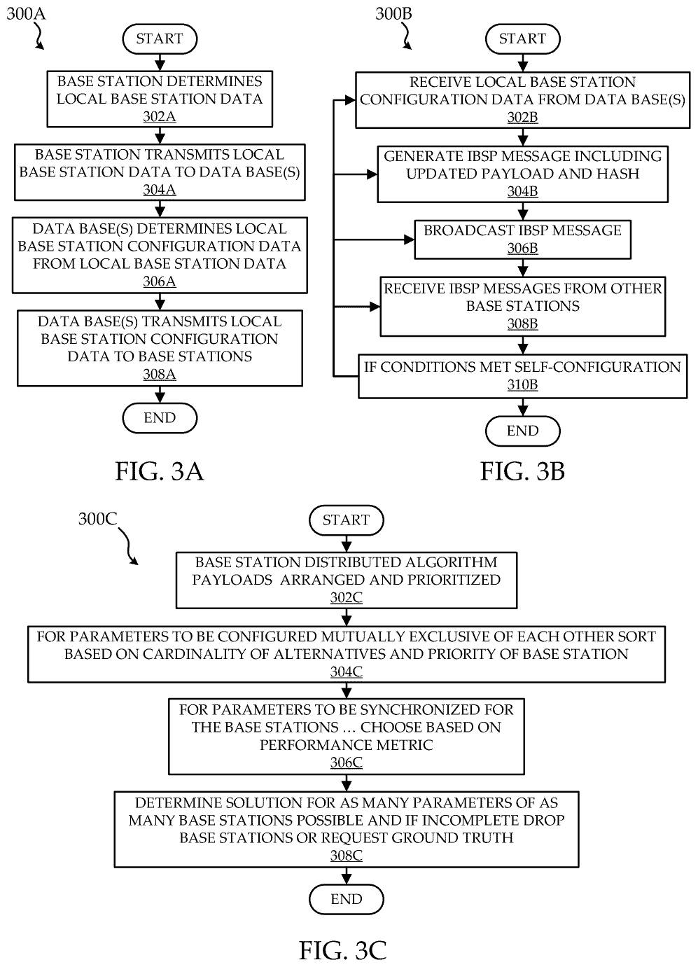

Referring also to FIG. 3A, a method 300A of exchanging data 202 between the base stations and the one or more data bases in an adaptive distributed configuration method will now be discussed.

Initially, the base stations 104 determine local base station data necessary for configuration 302A. Such may include for example, local conditions in the network, operating conditions of the base station, the base station's GPS location etc, After the base station data is determined it is transmitted 304A, to the one or more data bases 102, often in the form of a query or request for further configuration data from the one or more data bases 102, over links 103. The one or more data bases 102 with use of the local base station data determines operational parameters or operating limitations in the form of local base station configuration data 306A for the base stations. The local base station configuration data could for example contain a list of available channels for the base station or a priority assigned to the base station or a mode of operation for the base station etc. The one or more data bases 102 then transmits the local base station configuration data 308A to the base stations 104 over the links 103. Generally speaking, the configuration data includes all the local data necessary for the configuration processing to fix the operational parameters, however, since the base stations are to be operated in a coordinated fashion, configuration processing requires additional data pertaining to other base stations, e.g. other base station's available channels, priority, mode of operation etc., the base stations exchange configuration data 204 using the IBSP. Depending upon whether the configuration is global or local in nature these communications may extend to the exchange of information between all the base stations or only a relevant subset, group, or pair of the base stations in the network.

Referring also to FIG. 3B, a method 300B of exchanging data 204 using IBSP between the base stations in an adaptive distributed configuration method will now be discussed.

Unlike a negotiation with a central EMS, the configuration information now present in each base station 104 contains at least some degrees of freedom or unresolved multiple possibilities for one or more configuration parameters. Determining 206 what specifically each of these configuration parameters shall be fixed or resolved to is the responsibility of the distributed configuration processing 107 present in each of the base stations 104. In order to do this, first the local base station configuration data are exchanged among the base stations 104.

Initially, a base station 104 receives 302B its local base station configuration data from the one or more data bases 102 over links 103. The base station then generates 304B an IBSP message for broadcast to all the base stations, and includes updating the distributed algorithm payload and hash of that payload if it changes, for example, when distributed algorithm payloads from other base stations are received. Once generated the IBSP message is broadcasted 306B to the other base stations. The base station may also receive 308B IBSP messages from other base stations. If certain local conditions are met at the base station, for example it has all the payloads of all the known base stations, and all the hashes thereof, or a grace period has elapsed, the base station proceeds to self-configuration 310B. It should be noted that that periodically the base station 104 may check data bases 102 for any updates in configuration data.

Referring also to FIG. 3C, a method 300C of self-configuration 206 using the exchanged configuration data in an adaptive distributed configuration method will now be discussed.

Once the conditions are met 310B and self-configuration has commenced, the distributed algorithm payloads are arranged and prioritized 302C and in the case of parameters that are to be configured mutually exclusive of one another, the data is sorted based on cardinality of alternatives, and priority of the base station 304C to help ensure a solution is found efficiently and which favor base stations which are deemed more important. For parameters that are to be synchronized for the base stations, i.e. coordinated and in some case chosen to be the same, a performance metric is used 306C to determine the solution for all the base stations.

Configuration processing uses recursion and duplication removal to eventually arrive at a solution 308C simultaneously for as many parameters as possible, and if incomplete, base stations of lowest priority are dropped or a new request is sent to the one or more data bases for its ground truth solution.

### EXAMPLE 1: TV WHITE SPACE NETWORK SYSTEM

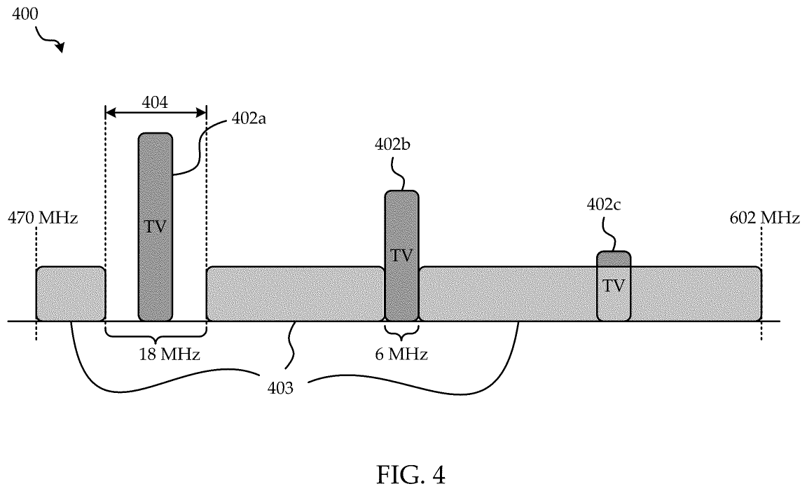

With reference also to FIGS. 4-9 an example adaptive distributed configuration in the context of a TV white space (TVWS) network system, will now be discussed.

Ultra-long-range wireless communications face the challenge of providing optimal wideband communications performance while avoiding interfering with occupied television (TV) broadcast channels. Wideband utilization of TV white space (TVWS) must meet regulations, limits, and requirements surrounding a TV white space (TVWS) spectrum. In Canada and the U.S., the TVWS spectrum covers several frequency ranges including the 470-602 MHz range, referred to hereinbelow as a target TVWS band.

White space communications apparatus or systems (also commonly referred to simply as white space devices or WSDs) are allowed to operate in TVWS bands in accordance with requirements of the TVWS database (WSDB). The WSDB provides to WSDs lists of available channels and corresponding maximum permitted power levels for each available channel, based upon the geolocation of the WSD, for protecting communications of licensed services and systems including broadcast TV stations in the area.

WSDs can use TV channels in TVWS bands that are indicated as available by the WSDB. Depending on the WSD location and transmit power, the requirements of the WSDB may block or restrict the WSD's access to occupied TV channels and adjacent TV channels, to protect nearby TV broadcast stations. As a result, the available TVWS spectrum may include several non-contiguous frequency blocks.

Regulatory bodies such as the Federal Communications Commission (FCC) and Innovation, Science and Economic Development Canada (ISED) specify out-of-band emission (DOBE) requirements for TVWS operation which define emission limits outside of any utilized contiguous frequency block. For wideband operation using multiple non-contiguous frequency blocks, the WSD must meet the DOBE requirements in the frequency gaps between non-contiguous blocks.

With reference to FIG. 4, an example 400 of available bandwidth within a target TVWS band spanning 470 MHz-602 MHz in accordance with regulatory requirements for a white space communications system located in proximity to TV broadcast stations will now be described.

The available white space spectrum 403 for use by WSDs is limited by current U.S. and Canadian regulatory requirements, which specify the size of blocked frequency segments for the protection of each TV channel 402 depending on the location and power of the WSD device. When a WSD is located close enough to a TV station and/or operating at a high enough power, an occupied TV channel 402a is protected by a blocked frequency segment 404 three TV channels (e.g., 18 MHz) wide, whereas when the WSD is located farther away or operating at lower power, an occupied TV channel 402b is protected by a blocked frequency segment one TV channel wide (e.g., 6 MHz). When a WSD is located far enough from a TV station and/or operating at a low enough power, the WSD may utilize the TV channel 402c for communications.

In a network system 100 of TVWS (Television Whitespace) radio base stations 104, the frequencies that the radio base stations 104 are allowed to operate on are determined by their GPS position and hence they must exchange configuration data with a white space database 102. After having determined its own GPS location as in 302A of method 300A, the TVWS radio base stations 104 reach out 304A to a WSDB (Whitespace Database) 102, provide valid credentials and their respective GPS positions and the WSDB determines a set of appropriate allowable channels 306A and transmits that list 308A of channels (frequencies) that the radio base station may use, to the radio base station. Selecting which channel to use is left up to the radio base stations themselves.

In a network with several base stations (BSs), each BS will have to perform the exchange with the white space data base and each BS will obtain its own list of available channels. These lists will often contain common channels, but may also contain unique channels depending on the GPS locations of the BSs.

In a known manual system a technician would typically configure each BS with a unique channel from their respective channel lists. As the BS network size grows, this can become somewhat tedious and to complicate matters, BSs need to periodically check back with the WSDB and get updated channel lists. It is quite possible for channel lists to change, and if the particular channel that a BS was using becomes unavailable, the BS has little recourse except to shut down until a technician can assign a new channel.

In contrast to such a system, implementing adaptive distributed configuration of a group of BSs in a wireless system, allows channels to be determined automatically, and adapt automatically (with minimal changes) as WSDB channel lists change, or when BSs are added to (or removed from) the group. It also has no single point of failure, so it adapts as BSs enter and exit the network.

Whenever a BS receives 302B a new channel list from the WSDB, it generates an IBSP 304B and broadcasts that list (along with other information) 306B to all other members of the BS group. All BSs receive 308B and organize this information in a specific way 304B, then calculate 310B a channel allocation solution for self-configuration using configuration processing 107. The process guarantees that all BSs arrive at the same solution so each BS can safely configure its own active channel. If a complete solution for all BSs is not possible, one or more low priority BSs can be automatically shut down allowing the remaining high priority BSs to operate.

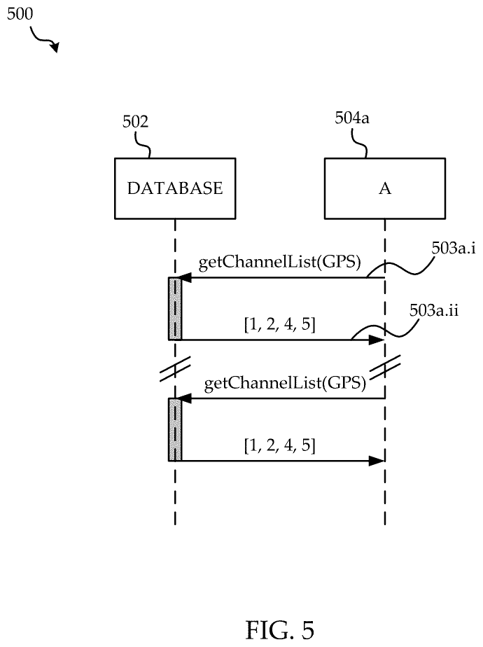

With reference to FIGS. 5-9, example messaging utilizing an IBSP for the TVWS example, and in connection with the methods depicted in FIGS. 3A and 3B, will now be discussed.

In the example embodiment, base stations 104 broadcast IBSP packets to their peers. The IBSP protocol does not need to use a reliable transport (i.e., it could be implemented using UDP). The number of peers (base stations) does not need to be known ahead of time and does not need to be fixed (i.e., can change). The broadcast domain should be limited to the base station network.

The IBSP packet is generated 304B including a base station ID (BSID), a distributed algorithm payload (DAP), and a hash of all DAPs known by the base station.

It should be noted that the Distributed Algorithm Payload (DAP) could be formatted in many different ways (e.g., proprietary, ASN.1, JSON, XML), and calculating a hash over a collection of DAPs should always yield the same hash value regardless of the order the DAPs were received (i.e., collection (tuple (BSID, DAP)) must always sort into a unique order)

In this TVWS example, the DAP of a BS includes the valid channel list e.g. [1, 3, 4] provided to the BS from the WSDB, and in general contains whatever information is used by the distributed configuration processing to reach a consensus on the configuration of all base stations. The hash of all DAPs known to a BS, is used to determine whether a base station has the same set of DAPs as its peers which in some embodiments is a condition to be met for self-configuration 310B. Whenever a base station receives a IBSP packet 308A with a different hash it incorporates whatever DAP is included in the IBSP packet into its own collection of known DAPs, generates a new hash value, and responds with a new IBSP packet.

FIG. 5 illustrates example messaging 500 in the exchange of configuration data between a BS A 504a and a WSDB database 502 such as an FCC database.

Each TVWS base station 504a must receive a channel list from a recognized FCC database 502 by providing suitable credentials, and the GPS position of the base station 503a.i. The FCC database 502 returns a list of channels 503a.ii that may be used at that GPS location. Stations are required to periodically refresh the list and adapt to any changes within a specified time. All subsequent diagrams assume that base stations perform this FCC database lookup behind the scenes, so database interactions will not be shown.

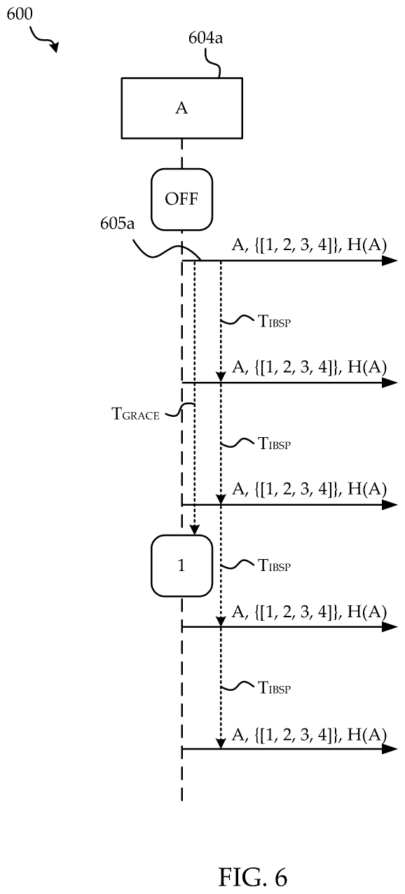

FIG. 6 illustrates example messaging 600 of a first base station A 604a shortly after powering up.

Initially the BS A 604a is “OFF”. When the BS A 604a powers up, it obtains a channel list from the FCC database and sends an IBSP packet 605a containing its identity “A”, the channel list DAP [1, 2, 3, 4] and a hash of all DAPs it knows about (i.e., which at that moment is just its own) denoted “H(A)”. To allow for dropped IBSP packets (rare, but possible), BS A 604a periodically resends the IBSP packet (i.e., repeatedly after time period T_{IBSP}). After a grace time period T_{GRACE}, if it has not heard back from any other base stations, it chooses a channel (using the distributed configuration processing for TVWS) which configures the BS A 604a for using channel “1” and starts transmitting. In the following illustrations, IBSP retransmissions have been omitted for simplification of illustration.

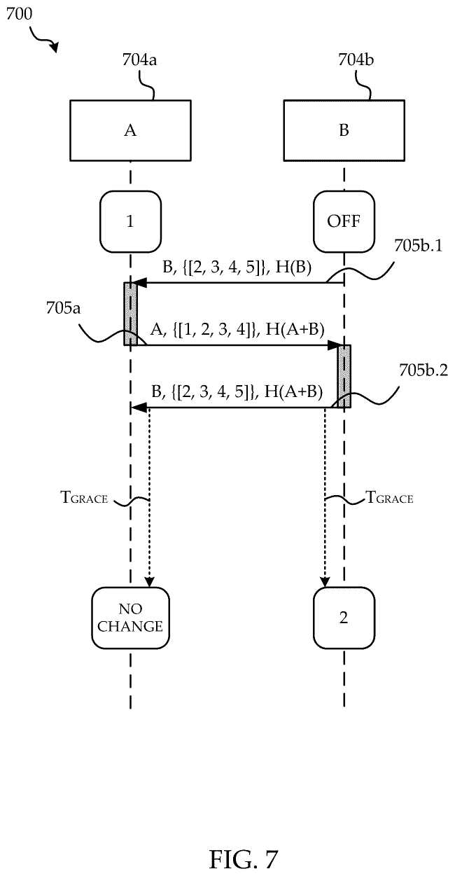

FIG. 7 illustrates example messaging 700 of a first BS 704a and a second BS B 704a shortly after the second BS B 704b powering up in the presence of a first BS A 704a.

Initially the first BS A 704a is using channel “1” and the second BS 704b is “OFF”. When the BS B 704b powers up, it obtains a channel list from the FCC database and sends a first IBSP packet 705b.1 containing its identity “B”, the channel list DAP [2, 3, 4, 5] and a hash of all DAPs it knows about (i.e., which at that moment is just its own) “H(B)”. In response to receiving the IBSP packet from the second BS B 704b, the first BS A 704a transmits an IBSP packet 705a containing its channel list DAP [1, 2, 3, 4], as well as the hash of both its own DAP and the DAP it received from BS B 704b, namely H(A+B). In response to receiving the IBSP packet from BS A 704a, the second BS B 704b generates 304B a new IDBP packet 705b.2 with an updated hash now including the DAP of BS A 704a, namely H(A+B) and broadcasts it. On receiving the same hash it sent and after a grace period T_{GRACE} the first BS A 704a self-configures using configuration processing 310B but does not change the channel it is transmitting on because BS B 704b has other alternatives. The second BS B 704b after the grace time period T_{GRACE}, self-configures using configuration processing 310B and chooses channel “2” after which it starts transmitting.

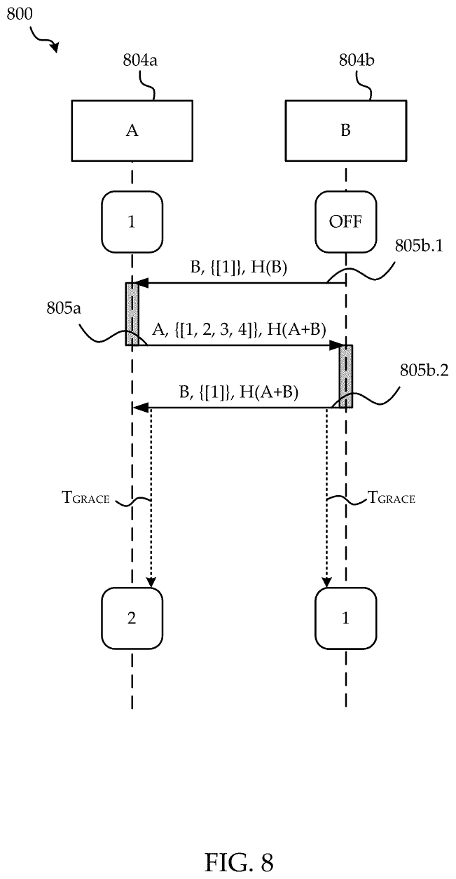

FIG. 8 illustrates example messaging 800 of a first BS A 804a and a second BS B 804b shortly after the second BS B 804b powering up in the presence of the first base station A 804a.

Initially the first BS A 804a is using channel “1” and the second BS 804b is “OFF”. When the BS B 804b powers up, it obtains a channel list from the FCC database and sends a first IBSP packet 805b.1 containing its identity “B”, the channel list DAP [1] and a hash of all DAPs it knows about (i.e., which at that moment is just its own) “H(B)”. In response to receiving the IBSP packet from the second BS B 804b, the first BS A 804a transmits an IBSP packet 805a containing its channel list DAP [1, 2, 3, 4], as well as the hash of both its own DAP and the DAP it received from BS B 804b, namely H(A+B). In response to receiving the IBSP packet from BS A 804a, the second BS B 804b generates 304B a new IDBP packet 805b.2 with an updated hash now including the DAP of BS A 804a, namely H(A+B) and broadcasts it. On receiving the same hash it sent and after a grace period T_{GRACE} the first BS A 804a self-configures using configuration processing 310B and changes the channel it is transmitting on because BS B 804b has no other alternatives other than to use the channel “1” which BS A 804a was using. The second BS B 804b after the grace time period T_{GRACE}, self-configures using configuration processing 310B and chooses channel “1” after which it starts transmitting. Since the distributed TVWS configuration processing determines the channels for each BS, each base station can determine how to configure itself without further or multiple explicit interactions with the peer station (except to exchange channel lists).

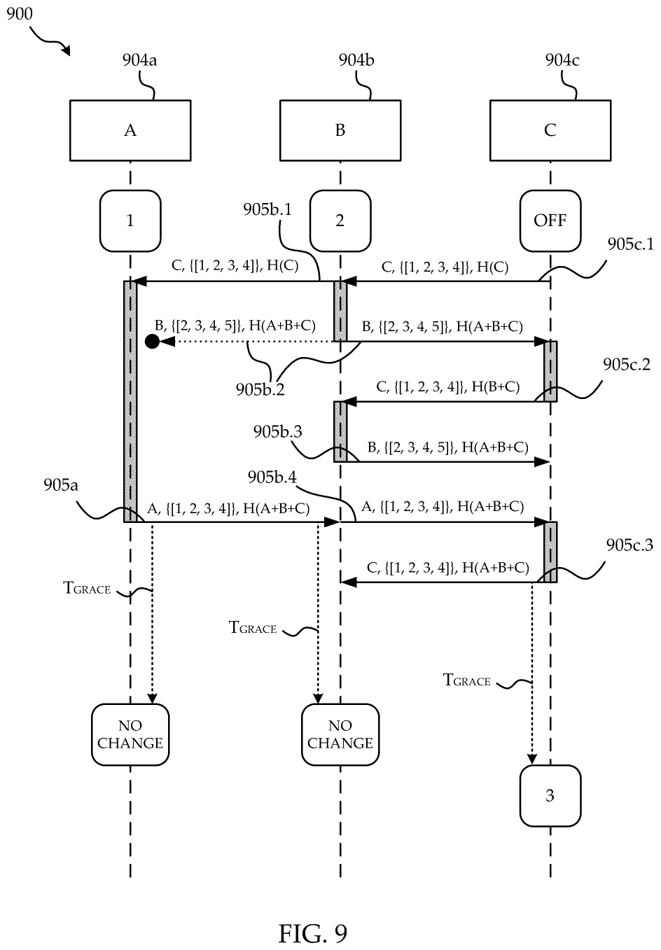

FIG. 9 illustrates example messaging 900 of a first BS A 904a, a second BS B 904b, and a third BS C 904c shortly after the third BS C 904c powering up in the presence of the first and second base stations 904a 904b.

Initially the first BS A 904a is using channel “1”, the second BS A 904b is using channel “2”, and the third BS 904c is “OFF”. When the BS C 904c powers up, it obtains a channel list from the FCC database and sends a first IBSP packet 905c.1 containing its identity “C”, the channel list DAP [1, 2, 3, 4] and a hash of all DAPs it knows about (i.e., which at that moment is just its own) “H(C)” which arrives at the second BS B 904b, and is broadcast also to the first BS A 904a. In response to receiving the IBSP packet from the third BS C 904c, the second BS B 904b broadcasts an IBSP packet 905b.2 containing its channel list DAP [2, 3, 4, 5], as well as the hash of both its own DAP and the DAPs it received from BS A 904a and BS C 904c, namely H(A+B+C). In this example one of these 905b.2 broadcast packets, namely, the one meant for the first BS A 904a is lost. In response to receiving the IBSP packet from BS B 904b, the third BS C 904c generates 304B a new IBSP packet 905c.2 with an updated hash now including the DAP of BS B 904b, namely H(B+C) and broadcasts it. On receiving a different hash than what it sent, the second BS B 904b broadcasts another IBSP packet 905b.3 with its DAP and hash of all the DAPs it is aware of. After some time and after receiving the broadcast packet originating with the third BS C 905c, the first BS A 905a broadcasts an IBSP packet 905a with its DAP [1,2,3,4] and the hash of all the DAPs is has received, namely, H(A+B+C) which is received by BS B 904b and broadcast as IBSP 905b.4 and received by the third BS C 904c. On sending the same hash it received previously, namely, H(A+B+C), and after a grace period T_{GRACE} the third BS C 904c self-configures 310B using configuration processing and chooses channel “3” after which it starts transmitting. Both the first and the second BSs 904a 904b, after a grace period T_{GRACE} following its last sending an IBDP packet self-configure 310B using configuration processing and both choose the same channel they were previously transmitting on. It should be clear that generally the stations continually send their DAPs until all stations agree on the hash values.

Although not shown or discussed in detail, it is to be understood that the white space communications systems also include various further processing and circuitry for supporting operations such as establishing communications with a WSDB, retrieving and storing relevant information retrieved therefrom, and in accordance therewith, processing and controlling all the above described circuitry. Further details of known approaches to these are beyond the scope of this disclosure.

### EXAMPLE 2: FRAME SYNCHRONIZATION CONFIGURATION

In TDD based wireless networks, the quantity of downlink (DL) or uplink(UL) subframes used in the radio frame structure is either selected based on a fixed frame (FF) or a variable frame (VF) approach. Fixed frame approaches require time synchronization of FFs to ensure alignment of downlink and uplink subframes whereas in a variable frame approach VFs can be transmitted on demand based on traffic loading. There is a tradeoff between reduced interference in the FF approach vs higher throughput in the VF approach. Selecting the frame sub-division is left up to the network operator.

When using a VF approach, the decision to adapt the frame DL/UL ratio occurs at the end of each scheduler cycle duration. Based on the DL/UL queue depths, in other words the number of bytes awaiting transmission, the ratio of DL to UL can be used to specify the quantity of DL or UL sub-frames. The data is packaged into the subframe in prespecified quantity and size of blocks (a set of OFDM symbols), and any overflow is buffered for the next allocation.

When using an FF structure, all base stations time synchronize their frame structures such that transmission and reception occur simultaneously for all. This is common in LTE as there are 7 TDD configs 0 to 6, with 9 special subframe configurations. As there is reduced transmission overlap during the DL and UL subframes, self-interference in the network is reduced and SINR is improved. Regardless of approach be it VF or FF, the frame structure is typically fixed making it predictable with a frame time equal to DLtime+ULtime+Max Round Trip Delay.

In a network with several base stations (BS), it is known to have each BS exchange its state information with a central mediator such as an element management system (EMS). EMS' typically push configuration information to managed radio nodes or pull state information from that radio node. An EMS is the single source of truth for the radio configuration set across the network. Presuming that network latency is quite small relative to the scheduler cycle duration, an EMS has been used to adaptively change the network configuration. Historically, the backhaul network has not been fast enough relative to the wireless network decision boundaries to ensure adaptive changes take effect promptly.

In contrast to such a system, implementing adaptive distributed configuration of a group of BSs in a wireless system, allows them to select the optimal subframe ratio for the group. The subframe ratio is selected automatically and adaptively with no single point of failure in the network. A central mediator such as an EMS or data base is only used to set the ground truth parameters that all radios need to comply with when in disagreement.

Within a scheduler cycle, each BS broadcasts a prioritized list of preferred subframe ratios to all other members of the group using an IBS protocol such as that describe above, but with relevant DAPs for the context. All BS organize this information and calculate the subframe ratio solution. In one embodiment, one or more performance metrics are used to determine parameters which optimize performance in the wireless network system. The configuration processing guarantees that all radios find the same solution so each BS can safely configure its subframe ratio. If a uniform solution is not possible, i.e. all BS cannot agree, then the ground truth set by the EMS or data bases will take precedence. It is a requirement that all BSs have synchronized their radio frames. The configuration processing ensures each BS will solve the problem uniformly eliminating the need for negotiation between the radios to come to an agreement.

There are many critical radio operating parameters that need to be closely managed in any network to ensure optimal performance. These optimal parameters are calculated based on physical radio details such as antenna height above ground level, antenna beam width and gain, antenna GPS location, antenna azimuth and vertical elevation. The solutions described herein operate without knowledge of these parameters. In some embodiments one or more of the following assumptions may be made: 1) the network runs on TDD, 2) all radios are independent but could be collocated, 3) no massive MIMO antennas are used, 4) all radios have a low-latency network connection to one another.

The above described methods may be performed by a processing in each relevant device such as the base stations and data bases or another such device which may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like, programmed according to the teachings as described and illustrated herein, as will be appreciated by those skilled in the computer, software and networking arts.

In addition, two or more computing systems or devices may be substituted for any one of the controllers or processing circuits described herein. Accordingly, principles and advantages of distributed processing, such as redundancy, replication, and the like, also can be implemented, as desired, to increase the robustness and performance of controllers described herein.

The operation of the example methods may be controlled or performed by machine readable instructions. In these examples, the machine readable instructions comprise an algorithm for execution by: (a) a processor, (b) a controller, and/or (c) one or more other suitable processing device(s). The algorithm may be embodied in software stored on tangible, non-transient media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the methods could be implemented by software, hardware, and/or firmware. Also, some but not all of the machine readable instructions represented may be implemented manually.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method for configuring a wireless network including a plurality of base stations and one or more data bases, the method comprising:
exchanging data for base station configuration between the base stations and the one or more data bases;
exchanging local base station configuration data between the base stations; and
self-configuring each base station with use of a configuration processing provided at each of the base stations, based on the local base station configuration data exchanged between the base stations.

2. The method of claim 1, wherein exchanging data for base station configuration comprises base stations sending local base station data to the one or more data bases.

3. The method of claim 2, wherein the local base station data comprises GPS locations of the base stations.

4. The method of claim 2, wherein the local base station data comprises data indicative of network conditions local to the base stations.

5. The method of claim 2, wherein exchanging data for base station configuration comprises the one or more data bases generating local base station configuration data including alternative parameters or operating limitations based on the local base station data received by the one or more data bases.

6. The method of claim 5, wherein exchanging data for base station configuration comprises the one or more data bases transmitting the local base station configuration data including alternative parameters or operating limitations to the base stations.

7. The method of claim 1, wherein the local base station configuration data includes a list of channels on which each base station may operate.

8. The method of claim 1, wherein exchanging local base station configuration data comprises the base stations generating and exchanging packets according to an inter-base station protocol (IBSP).

9. The method of claim 8, wherein the packets generated according to the IBSP include a payload including the local base station configuration data and a hash of all payloads known to a base station.

10. The method of claim 8, wherein the IBSP packets are exchanged by base stations broadcasting IBSP packets to all other base stations in the wireless network system.

11. The method of claim 9, wherein exchanging local base station configuration data comprises a base station determining that a hash function has not changed since a grace period has elapsed, and the base station subsequently commencing said self-configuring.

12. The method of claim 1, wherein the configuration processing provided at each of said base stations is the same and produces a same set of base station configurations including a configuration solution specific to the base station for self-configuring the base station.

13. The method of claim 12, wherein self-configuring is performed with use of the same configuration processing to coordinate operation of the base stations.

14. The method of claim 1, wherein self-configuration comprises determining from said exchanged local base station configuration data a priority for each base station.

15. The method of claim 14, wherein self-configuration comprises sorting said exchanged local base station configuration data based on a cardinality of alternative parameters in local base station configuration data and base station priority.

16. The method of claim 15 wherein cardinality of alternative parameters comprises a number of channels on which the base station may operate on.

17. The method of claim 15, wherein self-configuration comprises finding a configuration solution to mutually exclusive configurations using said sorting.

18. The method of claim 1, wherein self-configuration comprises determining from said exchanged local base station configuration, data parameters to be synchronized with use of a performance metric.
